(19) United States
(12) Patent Application Publication
(10) Pub. No.: US 2012/0243864 A1
(43) Pub. Date: Sep. 27, 2012

(54) OPTICAL COMMUNICATION DEVICE AND OPTICAL COMMUNICATION METHOD

(75) Inventor: Mariko SUGAWARA, Kawasaki (JP)

(73) Assignee: FUJITSU LIMITED, Kawasaki-shi (JP)

(21) Appl. No.: 13/336,084

(22) Filed: Dec. 23, 2011

(30) Foreign Application Priority Data
Mar. 25, 2011 (JP) 2011-068987

(51) Int. Cl. H04B 10/08

(52) U.S. Cl. 398/16

(57) ABSTRACT

An optical communication device includes an optical switch that switches a path of an optical signal; a first path that transmits an optical signal between a first communication unit and the optical switch; a second path that transmits an optical signal between a second communication unit and the optical switch; and a switch controller that controls the optical switch. After an optical connection between the first communication unit and the optical switch and an optical connection between the second communication unit and the optical switch are checked, the switch controller switches the path of the optical signal selected by the optical switch to enable optical communication between the first communication unit and the second communication unit.

### CROSS REFERENCE TO RELATED APPLICATIONS

This application is based upon and claims the benefit of priority of the prior Japanese Patent Application No. 2011-068987, filed on Mar. 25, 2011, the entire contents of which are incorporated herein by reference.

### FIELD

The embodiments discussed herein are related to an optical communication device with multiple blades that are mounted thereon and optically connected to each other, and an optical communication method.

### BACKGROUND

Recently, increase of transmission speed of electrical transmission is reaching its limit due to increased traffic. In the feature, optical interconnect technology using light will be used in short-haul and medium-haul transmission for higher-capacity transmission. For example, interconnect technology is applied to a blade server in which multiple servers (blades) are inserted into a control plane, thereby replacing electrical transmission among the blades with optical transmission.

If the blades are connected one on one, the control plane becomes complicated due to many optical wirings provided thereon since an optical wiring is required even for blades that do not communicate with each other. Thus, a blade server (control plane) that switches optical path by an optical switch provided on optical paths has been suggested (see, for example, U.S. Pat. No. 7,452,236).

However, if optical transmission is applied to the blade server, very strong optical power is concentrated on an optical connector of a blade optically connected to the control plane since as many as several tens of channels are transmitted (if each blade has 50 channels, 100 optical wirings are provided for each blade).

The control plane usually checks whether a blade is mounted (connected) by an electrical detection of connection. However, an error can occur in the detection and a blade that is not connected to the control plane can be erroneously detected to be “connected.” In this case, an optical signal from a source blade leaks to the outside from the optical connector of the control plane, with strong optical power as described above. The optical power converged to one point and leaked from the optical connector exceeds eye-safety standards.

Even if the optical switch described in U.S. Pat. No. 7,452,236 is provided, the optical switch cannot switch the optical path appropriately when an error occurs in the electrical detection of the connection of the blade.

A shutter can be provided to cope with the erroneous detection and prevent the leak of the light, however, which results in increased complicity, increased elements, and increased cost. Thus, means for detection of connection are required that is safe and can satisfy the eye-safety standards with a simple configuration.

### SUMMARY

According to an aspect of an embodiment, an optical communication device includes an optical switch that switches a path of an optical signal; a first path that transmits an optical signal between a first communication unit and the optical switch; a second path that transmits an optical signal between a second communication unit and the optical switch; and a switch controller that controls the optical switch. After an optical connection between the first communication unit and the optical switch and an optical connection between the second communication unit and the optical switch are checked, the switch controller switches the path of the optical signal selected by the optical switch to enable optical communication between the first communication unit and the second communication unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram of an overall configuration of a blade server according to a first embodiment.

FIG. 2 is a flowchart of a detection of a connection of a blade according to the first embodiment.

FIG. 3 is a diagram of an overall configuration of a blade server according to a second embodiment.

FIG. 4 is a flowchart of a detection of a connection of a blade according to the second embodiment.

FIGS. 5A and 5B are diagrams of configuration examples of an optical switch used in the second embodiment.

FIG. 6 is a diagram of an overall configuration of a blade server according to a third embodiment.

FIG. 7 is a flowchart of a detection of a connection of a blade according to the third embodiment.

### DESCRIPTION OF EMBODIMENTS

Preferred embodiments of the technology disclosed herein are described in detail below with reference to the accompanying drawings.

An optical communication device disclosed herein can be applied to a blade server using optical interconnect technology. A pair of blades that transceiver optical signals is connected to a control plane (midplane) of the blade server via optical connectors. The control plane switches a path such that an optical signal does not reach a destination blade until optical connection of the blades is confirmed, and switches the path such that the optical signal reaches the destination blade when the connection is confirmed. Thus, leak of strong optical signal from the optical connector exposed on the control plane to the outside can be prevented when the destination blade is not connected to the optical connector.

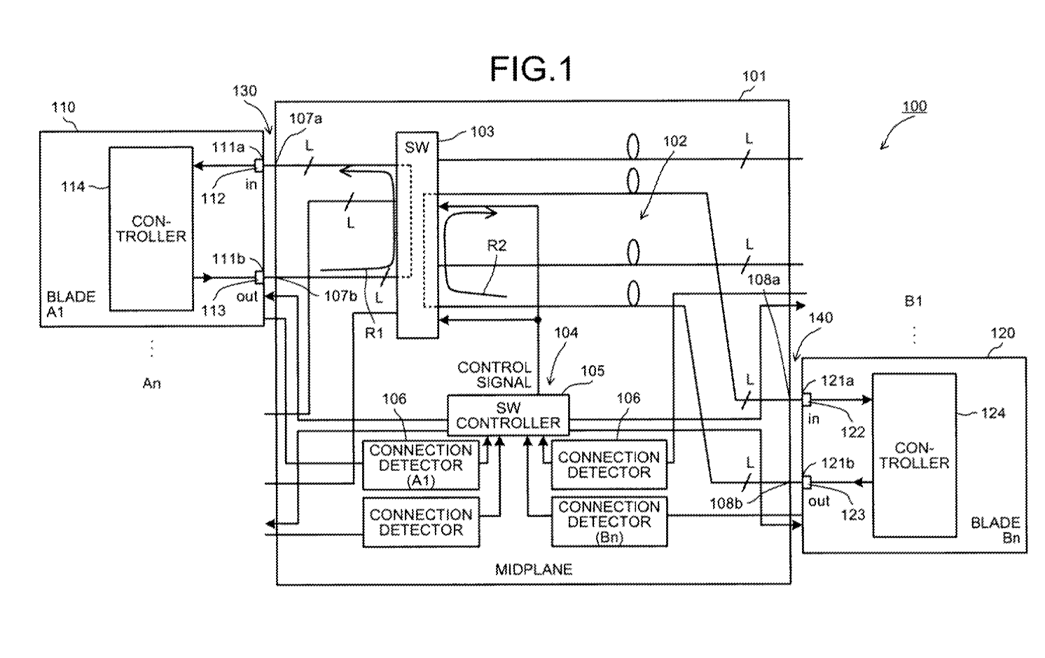

FIG. 1 is a diagram of an overall configuration of a blade server according to a first embodiment. A blade server 100 includes a control plane (midplane) 101, and blades 110 and 120 as communication units connected to the control plane 101. Multiple blades 110 and 120 are connected to the control plane 101 and transceive optical signals to each other. A check of optical connection between a first communication unit (blade) 110 and a second communication unit (blade) 120 is taken as an example in the following description.

Multiple paths 102 for optical signals are formed on the substrate of the control plane 101. The paths 102 include a path for transmission and a path for reception to transceive optical signals between one blade 110 and the other blade 120. In FIG. 1, the path for transmission and the path for reception are provided as a pair.

For each pair of the paths 102, the control plane 101 includes connectors 130 and 140 that relay optical signals between the blades 110 and 120. Although only two blades 110 and 120 are depicted in FIG. 1, many blades (A1 to An and B1 to Bn) are connected via many connectors in actuality. The connectors 130 and 140 not only relay optical signals, but also include wirings for signals to electrically detect the connection of the blades 110 and 120 to the connectors 130 and 140. The connectors 130 and 140 may have a function of fixing the blades 110 and 120 connected to the control plane 101.

As depicted in FIG. 1, the connector 130 on one end of the paths 102 on the control plane 101 includes an optical input port 107a and an optical output port 107b. Corresponding to the connector 130, the blade 110 includes an optical input port 111a and an optical output port 111b. Similarly, the connector 140 on the other end of the paths 102 on the control plane 101 includes an optical input port 108a and an optical output port 108b. Corresponding to the connector 140, the blade 120 includes an optical input port 121a and an optical output port 121b.

An optical switch (SW) 103 that switches optical path is provided on the paths 102 on the control plane 101. As depicted in FIG. 1, the optical SW 103 is provided on the paths 102 connected to all blades 110 and 120, thereby switching an optical signal to an arbitral path. The paths 120 between the blade 110 and the optical SW 103 during connection check is called “first path(s),” and the paths 120 between the blade 120 and the optical SW 103 is called “second path(s).”

Although a path including L channels are depicted as one path 102 in FIG. 1, the path includes n (for example, 50) optical paths in actuality.

The control plane 101 includes a controller 104 that controls path switching of the optical SW 103. The controller 104 includes a switch (SW) controller 105 and a connection detectors 106. The SW controller 105 causes the optical SW 103 to select a path for connection check of the blades 110 and 120, upon connection of the blades 110 and 120 to the connectors of the control plane 101.

The controller 104 is implemented by, for example, a computer including a CPU, a ROM, and a RAM and executing a given program. During the execution of the program, the controller 104 performs, as connection check when the blades 110 and 120 are mounted, path switching of the optical SW 103, output control of optical signals from the blades 110 and 120, and connection check based on the detection of the optical signals output from the blades 110 and 120 described later.

The SW controller 105 causes the optical SW 103 to select paths (i.e., paths R1 and R2 in FIG. 1 through which optical signals are looped back) such that optical signals are not output to their destinations (i.e., the optical input ports 111a and 121a of the blades 110 and 120) until the optical connection of the blades 110 and 120 is confirmed, and retains the switching state. The path R1 is formed only by the first paths, and the path R2 is formed only by the second paths.

When the optical connection of the blades 110 and 120 is confirmed, the SW controller 105 causes the optical SW 103 to select paths such that the optical signals are output to the destinations (i.e., the optical input ports 111a and 121a of the blades 110 and 120).

In the first embodiment, the detection of the connection of the blades 110 and 120 to the control plane 101 by the SW controller 105 includes the following two steps: 1. electrical detection by the connection detectors 106; and 2. optical detection using optical signals after the electrical detection. A minimum number of channels (for example, one channel) is used in the optical detection, thereby satisfying the eye-safety standards and achieving a safe detection of connection.

An existing technology can be used as the electrical detection by the connection detectors 106. For example, the connection detectors 106 transmit connection check signals to the blades 110 and 120, and determine the blades 110 and 120 are connected if the connection check signals are looped back by the blades 110 and 120 and input to the connection detectors 106 again. The connection detectors 106 determine the blades 110 and 120 are not connected if no loop-back is detected. Alternatively, the connection detectors 106 merely transmit the connection check signals to be looped back, and the SW controller 105 determines whether the blades 110 and 120 are connected.

The optical input ports 111a and 121a of the blades 110 and 120 include optical detectors 112 and 122 such as a PD to detect inputs of optical signals, respectively, and the optical output ports 111b and 121b include light-emitting elements 113 and 123 such as an LED to output optical signals, respectively.

An optical signal detected by the optical detector 112 of the blade 110 is output to the controller 114. An optical signal detected by the optical detector 122 of the blade 120 is output to the controller 124. During “2. optical detection” in the connection check described above, under the control of the SW controller 105 of the control plane 101 (i.e., based on control signals provided through electrical connection), the controllers 114 and 124 control emission of light from the light-emitting elements 113 and 123 and output whether optical signals are detected by the optical detectors 112 and 122 to the SW controller 105.

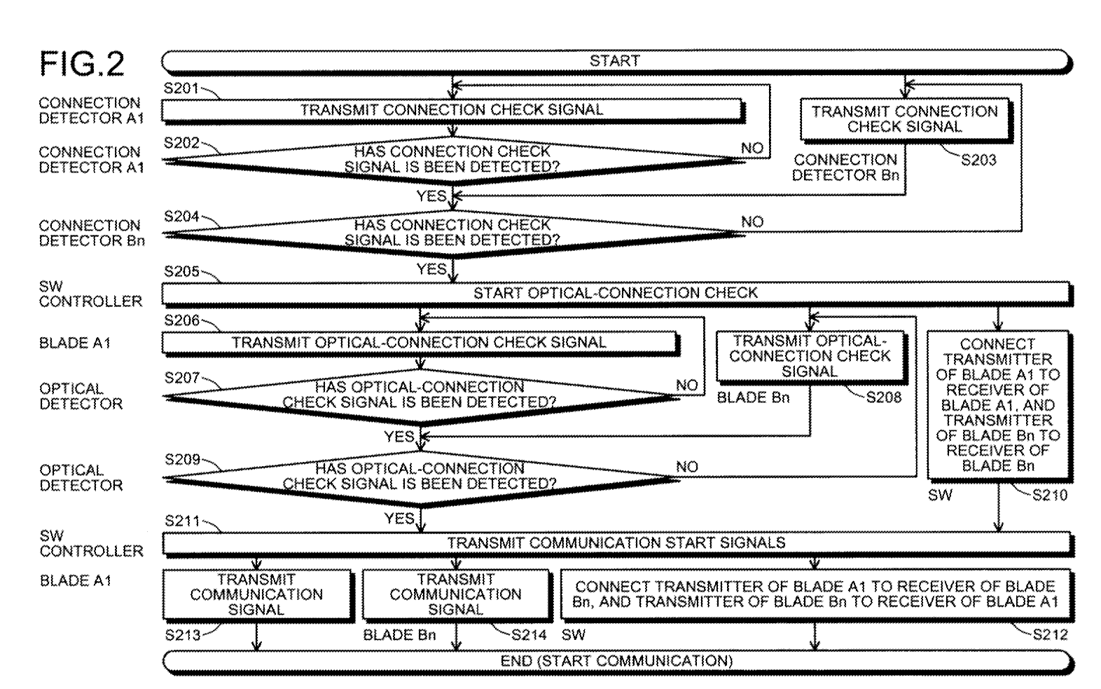

FIG. 2 is a flowchart of the detection of the connection of a blade according to the first embodiment. The detection of the connection of the blades A1 (110) and Bn (120) connected to the control plane 101 depicted in FIG. 1 is taken as an example.

A user mounts the blades A1 (110) and Bn (120) on the control plane 101 of the blade server 100, and then inputs a start signal of the detection from an external controller of the blade server 100. The control plane 101 starts the detection upon reception of the start signal.

As the first-stage connection check, the SW controller 105 causes the connection detectors 106 to electrically detect the connection of the blades A1 (110) and Bn (120) to the connectors. For example, the connection detector A1 (106) transmits a connection check signal to the blade A1 (110) (operation S201) and determines whether the connection check signal has been detected (operation S202). Similarly, the SW controller 105 causes the connection detector Bn (106) to transmit a connection check signal to the blade Bn (120) (operation S203) and determines whether the connection check signal is detected (operation S204). The determinations at operations S202 and S204 are made by the connection detectors 106 to which the connection check signals are looped back or the SW controller 105.

If both of the connection check signals are detected (operation S202: YES and operation S204: YES), the SW controller 105 starts the second-stage connection check (operation S205). If either of the connection check signals is not detected (operation S202: NO or operation S204: NO), the SW controller 105 does not start the second-stage connection check and returns to operation S201 or S203. Thus, output of optical signals from the blades A1 (110) and Bn (120) can be inhibited when the connection to the connectors is not electrically detected.

In the second-stage connection check, the SW controller 105 outputs start signals of optical connection check to the blades A1 (110) and Bn (120). The SW controller 105 also causes the optical SW 103 to select paths (i.e., paths R1 and R2 in FIG. 1) such that optical-connection check signals transmitted from the blades are looped back to the blades (operation S210).

The blades A1 (110) and Bn (120) transmit optical-connection check signals from the light-emitting elements 113 and 123 upon reception of the start signals. The blade A1 (110) transmits the optical-connection check signal from the light-emitting element 113 (operation S206) and determines whether the optical-connection check signal transmitted through the path R1 selected by the optical SW 103 has been detected by the optical detector 112 (operation S207). Similarly, the blade Bn (120) transmits the optical-connection check signal from the light-emitting element 123 (operation S208) and determines whether the optical-connection check signal transmitted through the path R2 selected by the optical SW 103 is detected by the optical detector 122 (operation S209). The determinations whether the optical-connection check signals are detected by the optical detectors 112 and 122 of the blades A1 (110) and Bn (120) are made by the SW controller 105 based on control signals provided through optical or electrical connection.

Although the blades A1 (110) and Bn (120) include L transceivers for L channels, the optical-connection check signal need not to be transmitted from all of the L channels. The optical connection can be checked by using at least one channel, thereby minimizing the optical power and satisfying the eye-safety standards.

If both of the optical-connection check signals are detected (operation S207: YES and operation S209: YES), the SW controller 105 transmits communication start signals to the blades A1 (110) and Bn (120) (operation S211). The order of the detection at operations S207 and S209 can be arbitrary.

If either of the optical-connection check signals is not detected (operation S207: NO or operation S209: NO), the SW controller 105 does not transmit the communication start signals. Thus, output of optical signals from the blades A1 (110) and Bn (120) can be inhibited when the optical-connection check signal(s) cannot be detected. For example, an optical signal from the blade A1 (110) can be prevented from reaching the destination blade Bn (120) until the destination blade Bn (120) is confirmed to be mounted (optically connected).

The SW controller 105 transmits the communication start signals (operation S211) and causes the optical SW 103 to restore the paths that connect the blades A1 (110) and Bn (120) (operation S212). The blades A1 (110) and Bn (120) respectively transmits a communication signal (operations S213 and S214), thereby starting mutual communication.

According to the first embodiment described above, the connection of the blades A1 (110) and Bn (120) to the control plane 101 is checked by two steps (i.e., the first-stage electrical connection check to electrically detect the connection to the connectors, and the second-stage optical connection check after the completion of the first-stage electrical connection check), thereby improving the reliability of connection check. Thus, leak of light from the optical input ports 107a and 108a of the control plane 101 can be prevented when the blade A1 (110) and/or the blade Bn (120) are not connected to the control plane 101.

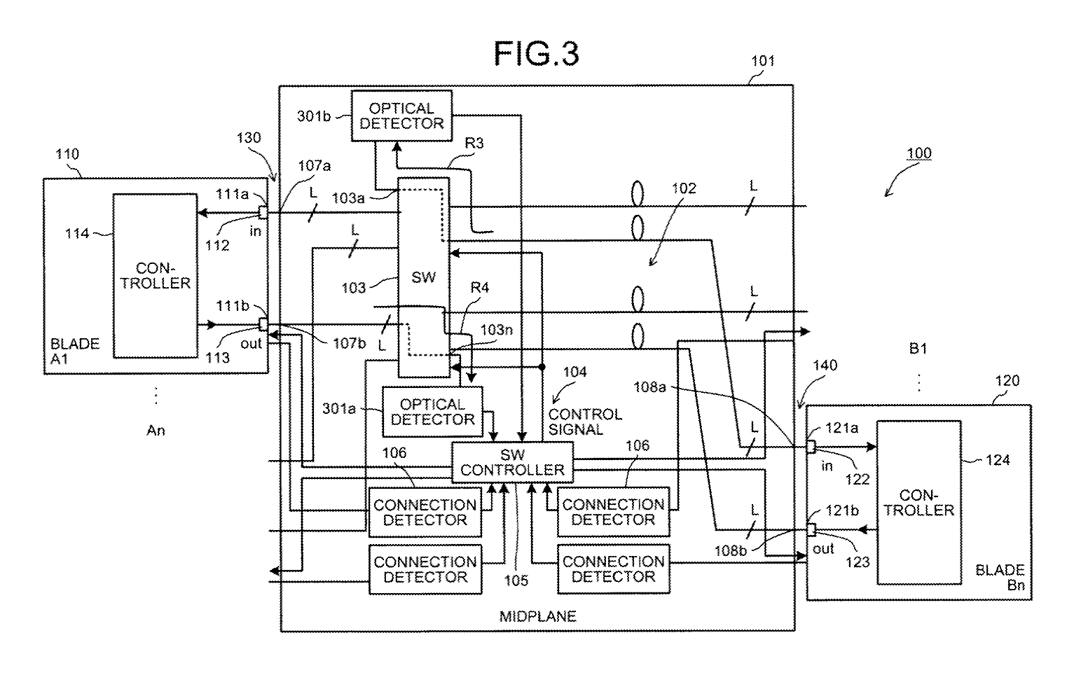

FIG. 3 is a diagram of an overall configuration of a blade server according to a second embodiment. Components of FIG. 3 similar to those of FIG. 1 are assigned same reference numerals, and description is omitted. The optical SW 103 according to the second embodiment includes ports for checking optical connection 103a and 103n to which optical detectors 301a and 301b are connected, respectively, thereby forming third paths.

Until the optical connection of the blades 110 and 120 is confirmed, the SW controller 105 causes the optical SW 103 to select paths R3 and R4 such that optical signals are output not to their destinations (i.e., the optical input ports 111a and 121a of the blades 110 and 120) but to the optical detectors 301a and 301b, and retains the switching state. The path R3 outputs a light from the second path not to the first path, but to the optical detector 301b. The path R4 outputs a light from the first path not to the second path, but to the optical detector 301a.

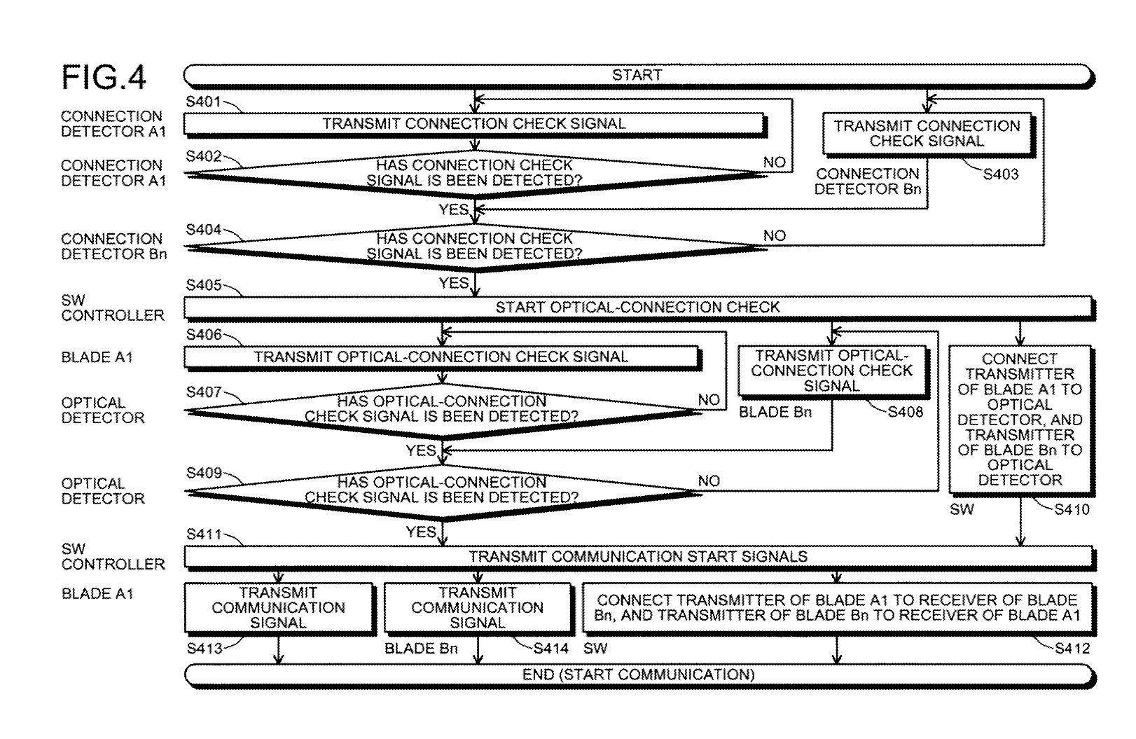

FIG. 4 is a flowchart of the detection of the connection of a blade according to the second embodiment. The first-stage connection check of FIG. 4 is the same as operations S201 to S204 of FIG. 2.

A user mounts the blades A1 (110) and Bn (120) on the control plane 101 of the blade server 100, and then inputs a start signal of the detection from an external controller of the blade server 100. The control plane 101 starts the detection upon reception of the start signal.

As the first-stage connection check, the SW controller 105 causes the connection detectors 106 to electrically detect the connection of the blades A1 (110) and Bn (120) to the connectors. For example, the connection detector 106 transmits a connection check signal to the blade A1 (110) (operation S401) and determines whether the connection check signal is detected (operation S402). Similarly, the SW controller 105 causes the connection detector 106 to transmit a connection check signal to the blade Bn (120) (operation S403) and determines whether the connection check signal is detected (operation S404). The determinations at operations S402 and S404 are made by the connection detectors 106 to which the connection check signals are looped back or the SW controller 105.

If both of the connection check signals are detected (operation S402: YES and operation S404: YES), the SW controller 105 starts the second-stage connection check (operation S405). If either of the connection check signals is not detected (operation S402: NO or operation S404: NO), the SW controller 105 does not start the second-stage connection check and returns to operation S401 or S403. Thus, output of optical signals from the blades A1 (110) and Bn (120) can be inhibited when the connection to the connectors is not electrically detected.

In the second-stage connection check, the SW controller 105 outputs start signals of optical connection check to the blades A1 (110) and Bn (120). The SW controller 105 also causes the optical SW 103 to select paths R4 and R3 such that optical-connection check signals are input to the optical detectors 301a and 301b (operation S410).

The blades A1 (110) and Bn (120) transmit optical-connection check signals from the light-emitting elements 113 and 123 upon reception of the start signals. The blade A1 (110) transmits the optical-connection check signal from the light-emitting element 113 (operation S406) and determines whether the optical-connection check signal transmitted through the path R4 selected by the optical SW 103 is detected by the optical detector 301a (operation S407). Similarly, the blade Bn (120) transmits the optical-connection check signal from the light-emitting element 123 (operation S408) and determines whether the optical-connection check signal transmitted through the path R3 selected by the optical SW 103 is detected by the optical detector 301b (operation S409). The determinations whether the optical-connection check signals are detected by the optical detectors 301a and 301b are made by the SW controller 105.

Although the blades A1 (110) and Bn (120) include L transceivers for L channels, the optical-connection check signal need not to be transmitted from all of the L channels. The optical connection can be checked by using at least one channel, thereby minimizing the optical power and satisfying the eye-safety standards.

If both of the optical-connection check signals are detected (operation S407: YES and operation S409: YES), the SW controller 105 transmits communication start signals to the blades A1 (110) and Bn (120) (operation S411). The order of the detection at operations S407 and S409 can be arbitrary.

If either of the optical-connection check signals is not detected (operation S407: NO or operation S409: NO), the SW controller 105 does not transmit the communication start signals. Thus, output of optical signals from the blades A1 (110) and Bn (120) can be inhibited when the optical-connection check signal(s) cannot be detected. For example, an optical signal from the blade A1 (110) can be prevented from reaching the destination blade Bn (120) until the destination blade Bn (120) is confirmed to be mounted (optically connected).

The SW controller 105 transmits the communication start signals (operation S411) and causes the optical SW 103 to restore the paths that connect the blades A1 (110) and Bn (120) (operation S412). The blades A1 (110) and Bn (120) respectively transmits a communication signal (operations S413 and S414), thereby starting mutual communication.

According to the second embodiment described above, the connection of the blades A1 (110) and Bn (120) to the control plane 101 is checked by two steps (i.e., the first-stage electrical connection check to electrically detect the connection to the connectors, and the second-stage optical connection check after the completion of the first-stage electrical connection check), thereby improving the reliability of connection check. Thus, leak of light from the optical input ports 107a and 108a of the control plane 101 can be prevented when the blade A1 (110) and/or the blade Bn (120) are not connected to the control plane 101. Further, since the second-stage optical connection check is performed by the optical detectors 301a and 301b provided on the control plane 101, the optical connection can be checked with a minimum number of optical detectors (in FIG. 3, two optical detectors 301a and 301b) even when the number of blades increases.

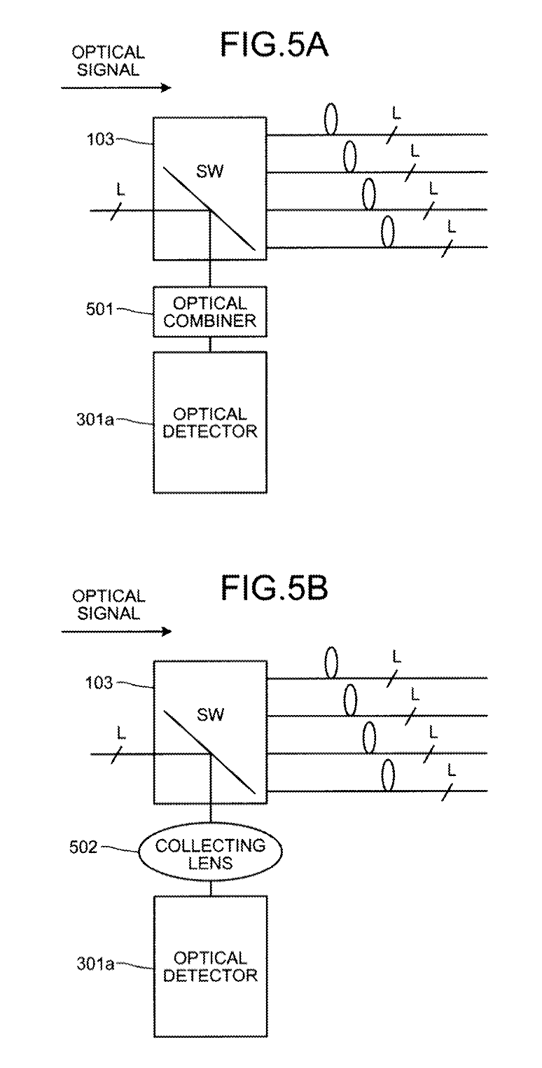

FIGS. 5A and 5B are diagrams of configuration examples of the optical switch used in the second embodiment. The optical switch depicted in FIG. 5A includes an optical combiner 501 (such as an optical coupler) that couples optical signals that are subjected to path switching and output from the optical SW 103 to the optical detector 301a, thereby enabling one optical detector 301a to detect n optical signals of L channels.

The optical switch depicted in FIG. 5B includes a collecting lens 502 that collects the optical signals of L channels output from the optical SW 103 to the optical detector 301a. Although only the optical detector 301a is depicted in FIGS. 5A and 5B, the optical detector 301b can adopt the same configuration. The number of optical signals detected in FIGS. 5A and 5B may be less than or equal to the number of channels.

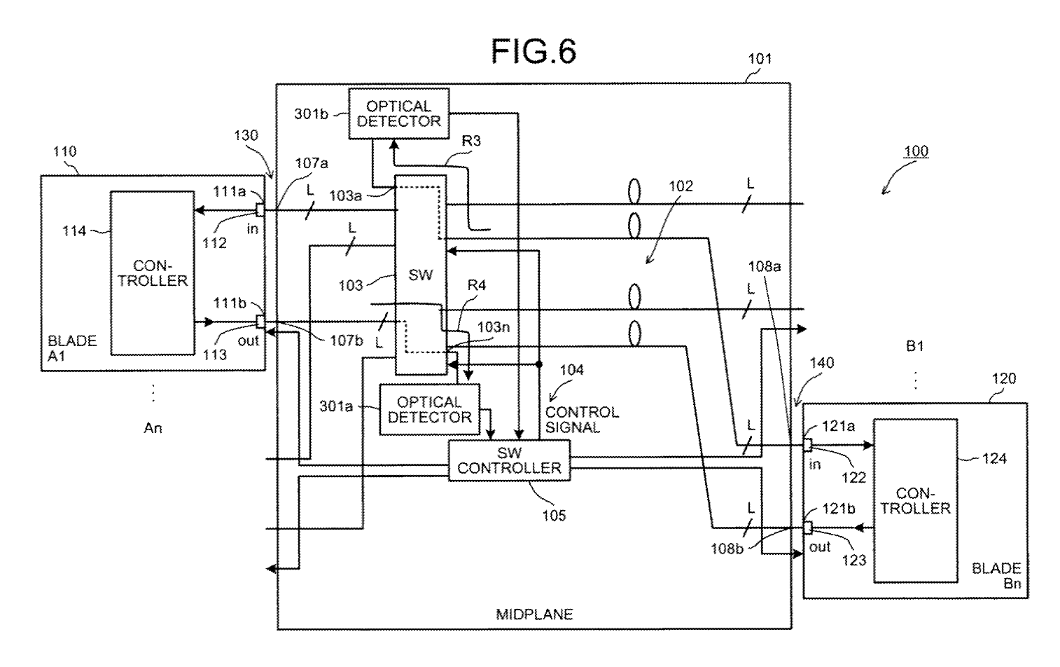

FIG. 6 is a diagram of an overall configuration of a blade server according to a third embodiment. FIG. 6 is the same as FIG. 3 (second embodiment) except that the electrical connection detectors 106 are removed. Components of FIG. 6 similar to those of FIG. 3 are assigned the same reference numerals, and description is omitted. In the third embodiment, the connection of the blades 110 and 120 to the control plane 101 is checked only by using optical signals.

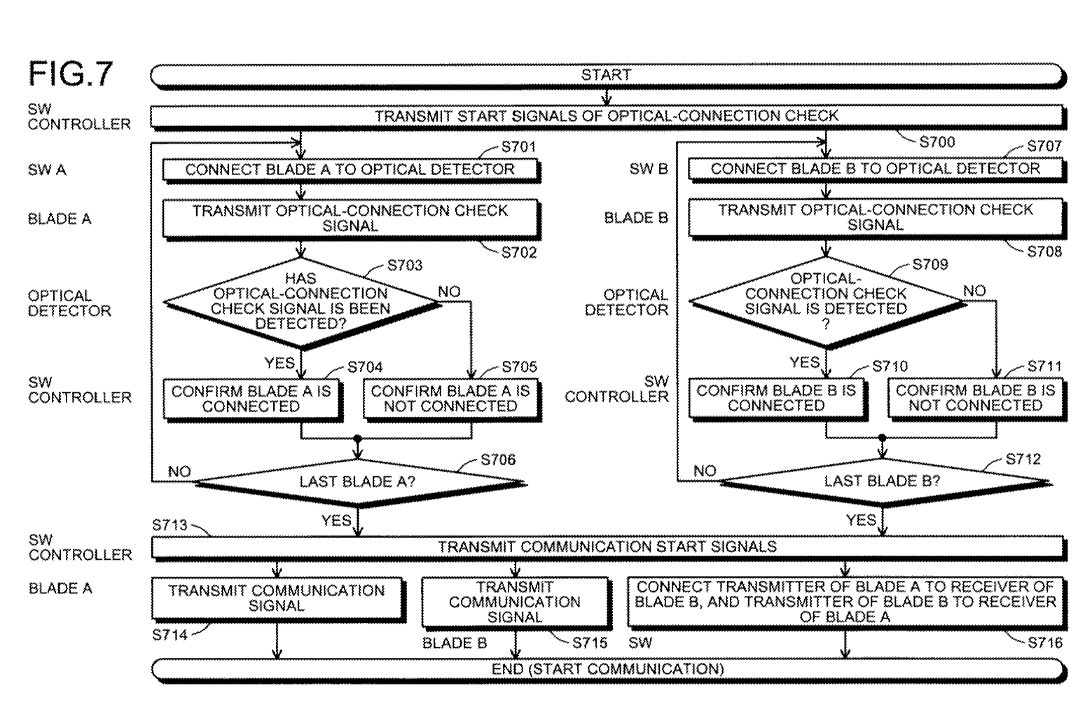

FIG. 7 is a flowchart of the detection of the connection of a blade according to the third embodiment. FIG. 7 depicts connection check of multiple blades A1 to An and B1 to Bn.

Processes for the blade A (operations S701 to S706) and processes for the blade B (operations S707 to S712) are performed simultaneously in parallel for each pair of the blade A (A1 to An) and the blade B (B1 to Bn) that transceive optical signals to each other, and performed for n pairs.

A user mounts the blades A (110) and B (120) on the control plane 101 of the blade server 100, and then inputs a start signal of detection of connection from an external controller of the blade server 100. The control plane 101 starts the detection upon reception of the start signal. In the third embodiment, the connection is checked by using optical signals. The SW controller 105 transmits start signals of optical connection check to the blades A and B (operation S700).

For convenience of description, processes for the blade A (110) are described first. The SW controller 105 switches an optical signal output from the blade A (110) to the path R4 to be output to the optical detector 301a (operation S701). The blade A (110) transmits an optical-connection check signal from the light-emitting element 113 upon reception of the start signal (operation S702). The SW controller 105 determines whether the optical-connection check signal is detected by the optical detector 301a (operation S703).

Although the blade A (110) includes L transceivers for L channels, the optical-connection check signal need not to be transmitted from all of the L channels. The connection can be checked by using at least one channel, thereby minimizing the optical power and satisfying the eye-safety standards.

If the optical-connection check signal is detected (operation S703: YES), the SW controller 105 confirms the blade A (110) is connected (operation S704). If the optical-connection check signal is not detected (operation S703: NO), the SW controller 105 confirms the blade A (110) is not connected (operation S705).

The operations described above are for connection check of one blade A (A1), and repeated for the next blade A (A2) up through the last blade A (An). That is, operation S701 and subsequent operations are repeated up to the last blade A (An) (operation S706: NO), and upon completion of the processes for the last blade A (An) (operation S706: YES), operation S713 is executed.

Processes for the blade B (120) are described next, which is the same as those for the blade A. The SW controller 105 switches an optical signal output from the blade B (120) to the path R3 to be output to the optical detector 301b (operation S707). The blade B (120) transmits an optical-connection check signal from the light-emitting element 123 upon reception of the start signal (operation S708). The SW controller 105 determines whether the optical-connection check signal is detected by the optical detector 301b (operation S709).

Although the blade B (120) includes L transceivers for L channels, the optical-connection check signal need not to be transmitted from all of the L channels. The connection can be checked by using at least one channel, thereby minimizing the optical power and satisfying the eye-safety standards.

If the optical-connection check signal is detected (operation S709: YES), the SW controller 105 confirms the blade B (120) is connected (operation S710). If the optical-connection check signal is not detected (operation S709: NO), the SW controller 105 confirms the blade B (120) is not connected (operation S711).

The operations described above are for connection check of one blade B (B1), and repeated for the next blade B (B2) up through the last blade B (Bn). That is, operation S707 and subsequent operations are repeated up to the last blade B (Bn) (operation S712: NO), and upon completion of the processes for the last blade B (Bn) (operation S712: YES), operation S713 is executed. For example, an optical signal from the blade A1 (110) can be prevented from reaching the destination blade Bn (120) until the destination blade Bn (120) is confirmed to be mounted (optically connected).

After the connection check of the blades A1 to An and B1 to Bn on the control plane 101 described above, the SW controller 105 transmits communication start signals (operation S713) and causes the optical SW 103 to restore the paths that connect each blade A (110) and a corresponding blade B (120) (operation S716). The corresponding blades A (110) and B (120) respectively transmits a communication signal (operations S714 and S715), thereby starting mutual communication.

According to the third embodiment described above, the connection of the blades A1 (110) and Bn (120) to the control plane 101 is checked only by using optical signals, thereby unnecessitating electrical connection check of the blades and enabling an easy detection of connection using optical signals.

According to the embodiments described above, the connection of the blades to the control plane is checked by using optical signals, thereby preventing erroneous detection of the connection of the blades and enhancing the reliability of connection check.

The optical communication method described in the embodiments may be implemented by executing a preliminarily prepared program, the program being executed by a computer such as a personal computer and a workstation. The program is recorded on a computer-readable recording medium such as a hard disk, a flexible disk, a CD-ROM, an MO, and a DVD and is read from the recording medium by the computer for execution. The program may be distributed through a network such as the Internet.

The technology disclosed herein can improve the reliability of the detection of the connection of the blades and satisfy the eye-safety standards with a simple configuration.

The controllers 114, 124 and the SW controller 105 can be comprised by circuit, processor which runs program, or Field-Programmable Gate Array (FPGA).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical communication device comprising:
an optical switch that switches a path of an optical signal;
a first path that transmits an optical signal between a first communication unit and the optical switch;
a second path that transmits an optical signal between a second communication unit and the optical switch; and
a switch controller that controls the optical switch, wherein
after an optical connection between the first communication unit and the optical switch and an optical connection between the second communication unit and the optical switch are checked, the switch controller switches the path of the optical signal selected by the optical switch to enable optical communication between the first communication unit and the second communication unit.

2. The optical communication device according to claim 1, wherein the switch controller checks the optical connection between the first communication unit and the optical switch by inputting the optical signal from the first communication unit to a path back to the first communication unit, and checks the optical connection between the second communication unit and the optical switch by inputting the optical signal from the second communication unit to a path back to the second communication unit.

3. The optical communication device according to claim 1, further comprising an optical detector that is connected to the optical switch by a third path and detects an optical signal, wherein
the switch controller checks the optical connections by inputting the optical signals from the first communication unit and the second communication unit to the optical detector.

4. The optical communication device according to claim 1, further comprising a connection detector that electrically detects a connection of the first communication unit and a connection of the second communication unit, wherein
after the connections are detected by the connection detector, the switch controller causes the first communication unit and the second communication unit to output the optical signals.

5. The optical communication device according to claim 2, wherein the first communication unit and the second communication unit respectively includes an optical detector that detects an optical signal, wherein
the switch controller determines, based on a result of detection by the optical detectors, the optical connection between the first communication unit and the optical switch and the optical connection between the second communication unit and the optical switch.

6. The optical communication device according to claim 3, further comprising an optical combiner that is provided between the optical switch and the optical detector and enables the optical detector to detect optical signals the number of which is less than or equal to the number of channels.

7. The optical communication device according to claim 3, further comprising a collecting lens that is provided between the optical switch and the optical detector and collects optical signals, the number of which is less than or equal to the number of channels, to the optical detector.

8. The optical communication device according to claim 1, wherein the switch controller minimizes the number of channels included in the optical signals for checking the optical connections of the communication units.

9. An optical communication method comprising:
checking an optical connection between a first communication unit and an optical switch and an optical connection between a second communication unit and the optical switch; and
switching a path of an optical signal selected by the optical switch to enable optical communication between the first communication unit and the second communication unit.

10. The optical communication method according to claim 9, wherein the checking includes
checking the optical connection between the first communication unit and the optical switch by inputting the optical signal from the first communication unit to a path back to the first communication unit, and
checking the optical connection between the second communication unit and the optical switch by inputting the optical signal from the second communication unit to a path back to the second communication unit.

11. The optical communication method according to claim 9, wherein an optical connection between the first communication unit and the optical switch and an optical connection between the second communication unit and the optical switch are checked by inputting the optical signals from the first communication unit and the second communication unit to an optical detector.
